(19) United States
(12) Patent Application Publication
(10) Pub. No.: US 2005/0066787 A1
(43) Pub. Date: Mar. 31, 2005

(54) Paper cutter

(75) Inventors: Makoto Mori, Tokyo (JP); Hideyuki Suzuki, Tokyo (JP); Masayuki Kato, Tokyo (JP); Ayano Yamashita, Tokyo (JP)

Correspondence Address: WOOD, PHILLIPS, KATZ, CLARK & MORTIMER, 500 W. MADISON STREET, SUITE 3800, CHICAGO, IL, 60661, US

(73) Assignee: Carl Manufacturing Co., Ltd.

(21) Appl. No.: 10/945,274

(22) Filed: Sep. 20, 2004

(30) Foreign Application Priority Data
Sep. 30, 2003 (JP) 2003-340064
Dec. 22, 2003 (JP) 2003-425603

(51) Int. Cl. G11B 5/027; B26D 7/02

(52) U.S. Cl. 83/452

(57) ABSTRACT

An end surface of a stopper is formed so as to be thick which is substantially the same surface as an outer circumferential surface of a flange portion, and the stopper is engaged with an engaging groove formed at the flange portion, whereby an engaging portion formed at a locking piece of the stopper is elastically deformed and engages with an engaging portion formed at the flange portion. When the stopper is pulled out in the direction away from the surface of the base resisting with elastic force of the engaging portion, an opening portion of a slot can be opened. The paper cutter of the invention enables to take the slider out of a plate in spite of having a simple configuration, and prevent a falling of the slider from the plate even in conveying it.

### BACKGROUND OF THE INVENTION

1. Field of the Invention

This invention relates to a paper cutter, and in particular, to a paper cutter in which a slider having a cutter slides along a slot of a plate.

2. Description of the Related Art

Conventionally, a paper cutter for cutting paper placed on a base by sliding a slider having a cuter along a slot of a plate is used. In this kind of paper cutter, when the slider having the cutter is taken out of the slot of the plate, space of the slot is broadened by twisting the plate, or the like, and the slider is taken out of the broadened space. That is, space through which a stopper formed at the back surface side of the slider can be taken out is formed by broadening the slot, and the slider is removed from the slot by taking out the stopper through the broadened space.

Moreover, in order to take the slider out of the slot, it is necessary to broaden the space of the slot and to move the slider to the area of the broadened space while maintaining the state of broadening the space. Further, when taking out the slider from the slot special attention is required so as not to cut fingers or the like by a cuter of the slider, and thus an operation of removing the slider becomes difficult.

In order to easily carry out an operation of removing the slider, a paper cutter is proposed, for example, in a patent application publication of US 2003/0140761 wherein slot width at both end portions of the slot are formed so as to be widened, and a slider can be taken out of the widened portion if the slider is moved toward the widened portion.

In the paper cutter described in the above-mentioned publication, as shown in FIG. 26, a rectilinear shaped plate 52 having a pair of arms 51 is rotatably provided on the base 50, and a slider 54 is accepted so as to be able to slide in a slot 53 formed at the plate 52. The plate 52 rotationally moves in the clockwise direction of FIG. 26 with the end portions of the pair of arms 51 serving as a shaft of rotational-movement, and therefore, unillustrated paper placed on the base 50 can be pressed and gripped by the plate 52. If the slider 54 is slid along the slot 53 in a state of pressing and gripping paper, the paper placed on the base 50 can be cut by the cutter disposed at the back surface side of the slider 54.

It is configured such that, when removing the slider 54 from the slot 54, if the slider 54 is moved toward widened portions 55 at the end portion sides of the slot 53 where the slot width are widened, the slider 54 can be taken out of the widened portion 55.

However, when the paper cutter described in Patent Document 1 is carried and conveyed, or the like, a situation in which the slider 54 moves toward an end portion of the slot 53 due to inclination of the base 50, and the slider 54 drops down from the widened portion 55, arises. In some cases, the slider may be lost, or the cutter of the slider 54 may hit a foot or the like or be stepped upon if it falls off.

The invention is to provide a paper cutter in which it is possible for a slider to be taken out of a plate even with a simple configuration, and there is no case in which the slider is taken off from the plate even during the time when the paper cutter is conveyed, and the plate can be locked as needed in a predetermined state without the plate being shaky.

### SUMMARY OF THE INVENTION

Problems of the invention can be solved by employing the following features.

That is, the main aspect of the invention provides a paper cutter comprising: a base; a rectilinear plate which is disposed on the base, and which is able to contact and separate with respect to the base; holding members which guide the plate so as to make it contact and separate with respect to the base, and which hold the plate; a slot formed along the direction of the length of the plate; and a slider which is accepted in the slot so as to be able to slide, and which has a cutter, wherein the slot has an opening portion opening at least up to one end portion of the plate, and a stopper which opens and blocks the opening portion is disposed at a portion of the holding members facing the opening portion or in the vicinity of the opening portion of the plate.

Preferably, the holding member is a pair of arm members which is rotatably supported by the base, and which rotatably supports the plate with respect to the base. Alternately, the holding member is a flange portion which is installed upright at a peripheral portion of the base, and the flange portion has a guide groove into which the plate is loosely fitted and is guided in the direction of the surface of the base.

Further preferably, the stopper is disposed so as to be rotatable or detachably attachable with respect to the holding members or the plate.

Still preferably, the paper cutter comprises guiding means for vertically sliding and guiding the stopper in an engaging groove formed at the holding members; and rotational-movement regulating means for locking the stopper so as not to be rotatable with respect to the holding members, at a position where the stopper is made to descend, in a standing state, by being guided by the guiding means, wherein, at a position where the stopper in a standing state is made to ascend by being guided by the guiding means, regulation on rotational-movement by the rotational-movement regulating means is released, and the stopper is rotatably supported in the directions in which the opening portion of the plate is opened and blocked.

In addition, it is preferable to comprise guiding means for vertically sliding and guiding the stopper in the engaging groove formed at the holding members; and maintaining means, which is provided at the guiding means, for allowing the stopper to rotationally move in the directions in which the opening portion of the plate is opened and blocked, at an ascended position of the stopper guided by the guiding means, and for maintaining the stopper, which is made to descend by being guided by the guiding means, in a standing state, when the stopper is rotationally moved in the direction in which the opening portion of the plate is blocked.

Moreover, the paper cutter comprises a locking member engaging with a part of a side edge of the plate in a state in which the plate is close to the base side, wherein the locking member is fitted and inserted into the part of the side edge of the plate on the base so as to be able to contact and separate with respect to the part of the side edge. Preferably, the locking member is urged toward the part of the side edge of the plate.

In the invention, in a paper cutter having a slider which is accepted in a slot formed at a rectilinear plate and slides along the slot, the slot is formed as a slot having an opening portion which opens at least up to one end portion of the plate, and a stopper which opens and blocks the opening portion is disposed at holding member for holding the plate or the plate.

In accordance therewith, the opening portion of the slot is opened by the stopper, and the slider can be easily taken out of the slot merely by making the slider slide toward the opening portion at the end of the slot. Further, if the opening portion of the slot is blocked by the stopper, the slider can be prevented from falling off the slot.

The stopper which opens and blocks the opening portion of the slot can be disposed at the holding member for holding the plate or the plate. A disposition of the stopper at the plate or the holding member can be configured so as to be detachably attachable with respect to the plate or the holding member, or may be configured so as to be rotatable with respect to the plate or the holding member.

As the configuration in which the stopper is detachably attachable with respect to the plate or the holding member, it can be configured in such a manner that an insertion portion such as an engaging groove into which the stopper is inserted, or the like is formed at the plate or the holding member, and engaging means for locking the stopper inserted in the insertion portion such as the engaging groove or the like, so as to be detachably attachable, is provided at the insertion portion such as the engaging groove or the like, and the stopper. Alternatively, the stopper can be configured so as to be removably adhered to the plate or the holding members, or detachably attached to the plate or the holding members by engaging-and-detaching means using a Hook-and-Loop fastener or the like.

Further, as the configuration in which the stopper is rotatable with respect to the plate or the holding member, it can be configured in such a manner that one end portion of the stopper is rotatably supported by the plate or the holding member, and engaging means for locking the stopper so as to be engaged and detached is provided at the other end side of the stopper and portions of the plate or the holding member touching that end side of the stopper at the time of closing the stopper.

Moreover, in a state in which the stopper stands, the stopper is disposed so as to be able to vertically slide by the guiding means in the engaging groove formed at the holding member, and further, it can be configured such that the stopper is rotatably supported in the directions in which the opening portion of the plate is opened and blocked, at a position where the stopper is made to ascend by the guiding means, and it can be configured so as to have rotational-movement regulating means for locking the stopper so as not to be rotatable with respect to the holding member, at a position where the stopper is made to descend by the guiding means.

Furthermore, it may be configured such that guiding means for vertically sliding and guiding the stopper in the engaging groove formed at the holding member and maintaining means for maintaining the stopper, which is made to descend by being guided by the guiding means, in a standing state are further provided. The maintaining means is preferably configured so as to allow the stopper to rotationally move in the directions in which the opening portion of the plate is opened and blocked, at the ascended position of the stopper guided by the guiding means, and so as to be able to maintain the stopper, which is made to descend by being guided by the guiding means, to be in a standing state, when the stopper is rotationally moved in the direction in which the opening portion of the plate is blocked.

The guiding means can be configured from a long groove vertically formed and a spindle such as a pin or the like sliding in the long groove, or the like. Further, the rotational-movement regulating means can be configured from a configuration in which rotational-movement of the stopper is regulated due to a projecting piece disposed in substantially parallel to the long groove and an end edge of the stopper touching the projecting piece, or a projecting portion or the like which can be inserted into the long groove.

The maintaining means can be configured from a second long groove disposed in the same direction as the aforementioned long groove which can carry out engagement and release when the stopper is rotationally moved in the directions in which the opening portion of the plate is blocked and opened at a position where the stopper is made to ascend, and a pin or the like which can engage with and release the second groove. Engagement and release between the pin and the second long groove can be carried out by forming an opening mouth toward the exterior at an end portion of the second long groove.

In accordance therewith, at a position where the stopper is made to descend in the engaging groove by the guiding means, even if force is applied to the stopper in the directions in which the opening portion of the plate is opened and blocked, the stopper is not rotationally moved, and the slider can be surely prevented from falling off the slot.

When a paper cutter with a long slot is used, paper to be cut by nipped between the plate and the base can be large-siz. In a case in which large-sized paper is cut, when the slider is slid in the slot, there are cases in which the slider strikes, with its own force, on the stopper disposed in the vicinity of the end portion of the slot. Even if the slider strikes on the stopper, the stopper is locked so as not to be rotatable with respect to the holding member, whereby the stopper is prevented from rotationally moving in the direction in which the opening portion of the plate is opened, and the slider can be surely prevented from falling off via the opening of the slot to the outside.

Further, due to the stopper being made to ascend in the engaging groove by the guiding means in a standing state, the stopper can be released from the rotational-movement regulating state, and the stopper can be rotationally moved in order to open and block the opening portion of the plate at the ascended position. Alternatively, if the stopper is further rotationally moved at the position where the stopper is made to ascend by the guiding means, the stopper can be in the engaging and non-engaging states with the maintaining means. Moreover, in a state in which the opening portion of the plate is opened because the stopper is rotationally moved, the slider can be easily pulled out of the slot.

In the invention, in a state in which the plate is close to the base side, a locking member engaging with the part of the side edge of the plate can be further provided. The locking member can be configured to be fitted and inserted so as to be able to contact and separate from the part of the side edge of the plate on the base.

As a close state of the plate toward the base side, when the plate is configured so as to be able to vertically contact and separate while maintaining a parallel state with respect to the plate, it is a state in which the plate contacts or is close to the base side, and when the holding member can be rotationally moved, it is a folding-over state in which the holding member is folded over toward the base side, and the plate held by the holding member contact or is close to the base.

As the close position of the plate with which the locking member engages toward the base side, it can be a position where the plate and the base contact one another in accordance with a configuration of the holding member, or can be a position where there is some gap between the bottom surface of the plate and the top surface of the base.

Because the state of the plate being close to the base side can be held by the locking member, the plate can be prevented from being shaky in conveying the paper cutter. If shakiness of the plate is prevented, for example, when the holding member can be rotationally moved, shakiness of the holding member can be prevented. In accordance therewith, a hinge portion or the like, with respect to the base, of the holding member can be prevented from being lost or the like due to shakiness. Accordingly, the paper cutter can be used in a stable state for a long time.

The locking member can be configured so as to be urged toward the part of the side edge side of the plate with which the locking member engages. In accordance therewith, the locking member is withdrawn resisting with urging force due to the plate being made to descend toward the base, and when the plate further descends, and the plate comes to a position close to the base side, the locking member is again advanced by urging force, and the locking member and the part of the side edge of the plate can be automatically engaged with one another.

As a shape of the stopper, as long as it is a configuration in which the slider can be prevented from falling off the slot, any configuration can be used. Further, as the guiding means, sa long as it is a configuration in which the stopper can be vertically slid in the engaging groove, any configuration can be used. Further, as the maintaining means, as long as it is a configuration in which the stopper is vertically slid in the engaging groove, and is in an engaging state and a non-engaging state at a position where the stopper is made to ascend, any configuration can be used.

In the invention, when paper placed on the base is cut by the cutter provided at the slider, a guiding groove into which the front end portion of the cutter is sunk, and which is parallel to the sliding direction of the slider can be formed on the base, and further, a mat or the like may be disposed so as to be parallel to the sliding direction of the slider, at the portion on which the front end portion of the cutter touches.

As the holding means of the plate with respect to the base, a configuration generally used for a paper cutter can be used such as a configuration in which the plate is rotatably held with respect to the base and a configuration in which the plate is guided by being flexibly urged in the direction of the surface of the plate.

Further, when the plate is made to be rotatable with respect to the base, as the direction of rotational-movement of the plate being away from the base, it may be a configuration in which the plate is rotationally moved from the end edge portion of the base to the outside, and it may be a configuration in which the plate is rotationally moved to the central side of the base, or it may be a configuration in which one end portion side of the plate is rotationally supported with spindle, and the other end side of the plate is made to stand with respect to the base.

### BRIEF DESCRIPTION OF THE DRAWINGS

FIG. 1 is an exploded view showing a whole body drawing of the invention. (First embodiment)

FIG. 2 is a schematic diagram for explanation of an attaching relationship between a stopper and a flange portion. (First embodiment)

FIG. 3 is a modified example for explanation of the attaching relationship between the stopper and the flange portion. (First embodiment)

FIG. 4 is another modified example for explanation of the attaching relationship between the stopper and the flange portion. (First embodiment)

FIG. 5 is another modified example for explanation of the attaching relationship between the stopper and the flange portion. (First embodiment)

FIG. 6 is a perspective view showing a whole body drawing of another paper cutter. (Second embodiment)

FIG. 7 is a diagram in which a plate of FIG. 6 is wide opened. (Second embodiment)

FIG. 8 is a schematic diagram for explanation of an attaching relationship between a stopper and arms. (Second embodiment)

FIG. 9 is a modified example for explanation of the attaching relationship between the stopper and the arms. (Second embodiment)

FIG. 10 is another modified example for explanation of the attaching relationship between the stopper and the arms. (Second embodiment)

FIG. 11 is another modified example for explanation of the attaching relationship between the stopper and the arms. (Second embodiment)

FIG. 12 is a schematic diagram for explanation of an attaching relationship between a stopper and a plate. (Third embodiment)

FIG. 13 is a modified example for explanation of an attaching relationship between a stopper and a plate. (Fourth embodiment)

FIG. 14 is a schematic diagram of main portions for explanation of the attaching relationship between a stopper and a flange portion. (Fifth embodiment)

FIGS. 15A to 15C are explanatory drawings showing operating situations of the stopper shown in FIG. 14. (Fifth embodiment)

FIG. 16 is a schematic diagram of main portions for explanation of an attaching relationship between another stopper and the flange portion. (Fifth embodiment)

FIG. 17 is a schematic diagram of main portions for explanation of an attaching relationship between other stopper and the flange portion. (Fifth embodiment)

FIG. 18 is a schematic diagram of main portions for explanation of an attaching relationship between a stopper and a flange portion. (Sixth embodiment)

FIG. 19 is a perspective view looked from the front surface of the stopper. (Sixth embodiment)

FIG. 20 is a perspective view looked from the back surface of the stopper. (Sixth embodiment)

FIG. 21 is a perspective view showing a whole body drawing of another paper cutter. (Seventh embodiment)

FIG. 22 is a top plane view showing the paper cutter shown in FIG. 21. (Seventh embodiment)

FIG. 23 is a bottom plane view showing the paper cutter shown in FIG. 21. (Seventh embodiment)

FIG. 24 is a partial sectional view of a locking member and a base. (Seventh embodiment)

FIGS. 25A to 25D are main portion plan views showing modified examples of an elastic member. (Seventh embodiment)

FIG. 26 is a schematic view showing a conventional example. (Conventional example)

### DESCRIPTION OF THE PREFERRED EMBODIMENTS

Preferred embodiments of the invention will be specifically described hereinafter on the basis of the attached drawings. Note that the invention is not limited to the embodiments which will be described hereinafter, and various modifications are possible.

(First Embodiment)

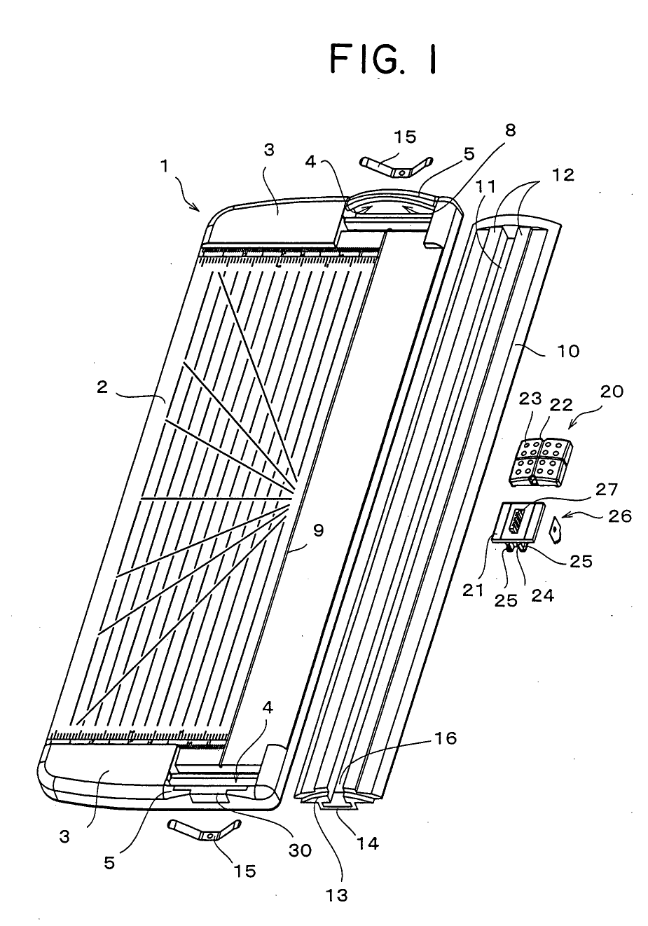

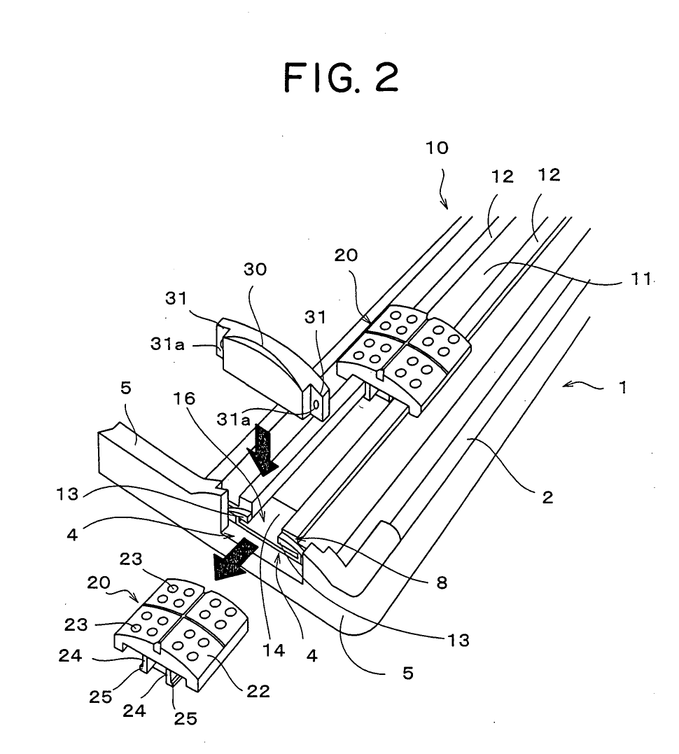

FIG. 1 is a whole body drawing in which main component members of a paper cutter in a first embodiment according to the invention are disassembled. FIGS. 2 to 5 are partial enlarged views showing a configuration of a stopper which opens and blocks an opening portion at an end portion of a slot and a state of taking-out a slider.

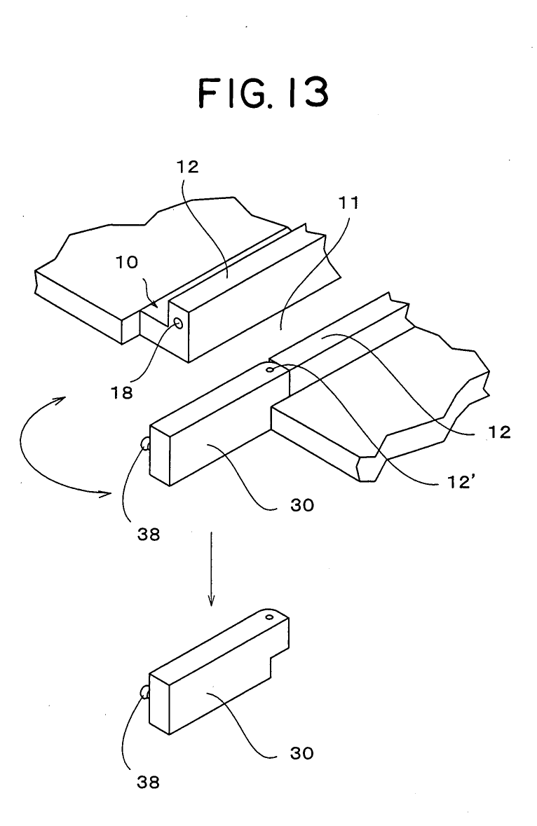

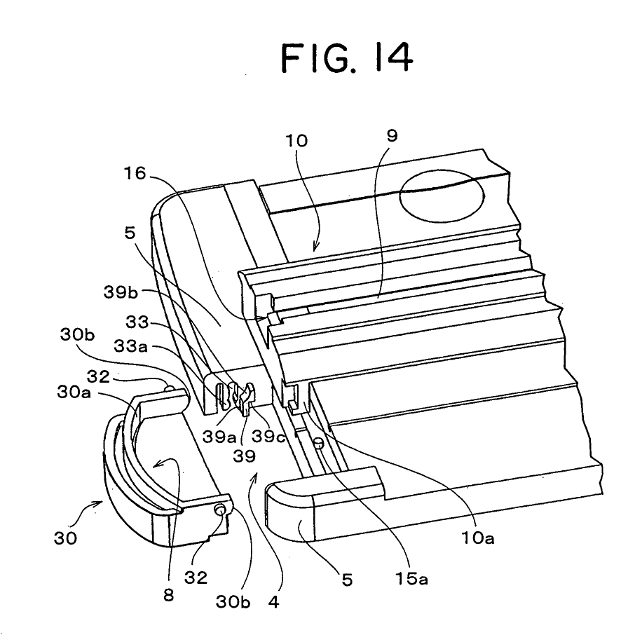

As shown in FIG. 1, a paper cutter 1 holds a plate 10 to which a paper presser plate is annexed, so as to be able to contact and be separated in the direction of the surface of a base, at end portions of a base 2. Further, springs 15 are interposed between the back surface side of the plate 10 and the base 2, and the plate 10 is urged upward by the springs 15. A slot 11 is formed along the direction of the length of the plate 10 at the center of the plate 10, and one end portion of the slot 11 is opened, and the one end portion is formed as an opening portion 16 at which a slider 20 can be inserted-into and taken-out along the direction of sliding of the slot 11. At the area on which the spring 15 is mounted, for example, a projection 15a is formed as shown in FIG. 14, and the spring 15 can be fixed to the base 2 if the projection and a hole formed at the center of the spring 15 are engaged with one another.

Guide rails 12 are formed at both side edges of the slot 11, and the slider 20 can be guided so as to slide along the slot 11 by the guide rails 12. The slider 20 is configured from a slider body 21 having a leg portion 24 guided by the guide rails 12, and a cover 22 attached to the slider body 21 so as to be detachably attachable.

The slider 20 may be configured so as to slide on the inner side surfaces or the outer side surfaces of the guide rails 12 as guide surfaces, or may be configured so as to slide in groove portions, serving as guide grooves, which are formed at the outer side surfaces sides of the guide rails 12. In this case, the leg portion 24 provided at the slider body 21 may be a member to be guided with respect to the above-described guide surfaces, or a member to be guided with respect to the above-described guide surfaces or the guide grooves may be formed at the back surface side of the slider body 21 or the cover 22.

A cutter holding hole 27 containing and holding a cutter 26 is formed at the slider body 21, and the cutter 26 is contained and held at the cutter holding hole 27 in a state in which one portion thereof is projected from the back surface side of the slider body 21. At the leg portion 24 formed so as to be installed upright at the slider body 21, an engaging portion 25 preventing the slider from falling off the slot 11 by engaging the back surface side of the guide rails 12 is formed.

Concave/convex portions 23 are formed on the surface of the cover 22 covering the top surface of the slider body 21, and they can prevent slippage with the palms, the fingertips, or the like. Further, a side surface portion of the cover 22 is formed in a shape having a predetermined thickness, and due to sliding of the slider 20 being carried out by the side surface portions of the cover 22 being easily gripped by the fingers or the like, thrust for cutting paper can be sufficiently transmitted to the slider.

Engaging convex portions 13 which engage with the guide grooves 8 of flange portions 5 formed at the both side edges of the base. 2, and are loosely fitted into the insides of the guide grooves 8, are formed at the both end portions of the plate 10. A pair of springs 15 urging the plate 10 in the direction away from the base 2 is disposed at the sides of both end portions of the plate 10. An ascended position of the plate 10 by urging force of the springs 15 is regulated by the guide grooves 8.

A bridge 14 linking between the left and right guide rails 12 and 12 so as to cross the opening portion 16 is formed at the back surface of one end portion of the plate 10. The bridge 14 is formed in a shape which does not interfere with the leg portion 24 and the engaging portions 25 formed at the end portions of the leg portion 24 when the leg portion 24 of the slider 20 is inserted into the slot 11 and taken out of the inside of the slot 11. The bridge 14 can be formed at the both end portions of the plate 10, or can be formed at only the end portion at which the opening portion 16 is formed.

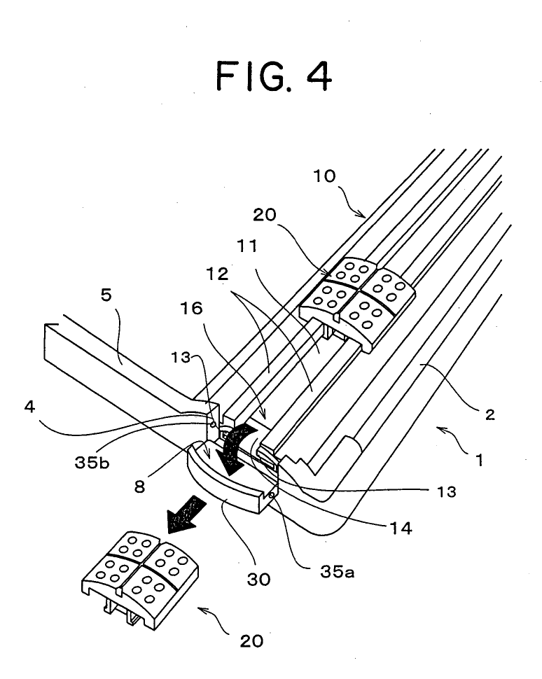

A stopper 30 is provided at the flange portion 5 facing the opening portion 16 of the slot 11, and the opening portion 16 is opened and blocked by the stopper 30. Further, a guide groove preventing the falling off the plate 10 by locking the engaging convex portion 13 formed at the plate 10 as shown in FIG. 4, is formed at the inner surface side of the stopper 30.

Note that, although not illustrated in the stopper 30 in FIGS. 1 to 3, and FIG. 5, a guide groove into which the aforementioned engaging convex portion 13 is loosely fitted is formed at the inner surface side of the stopper 30. Further the stopper 30 is engaged with the engaging groove 4 so as not to be slipped out of the engaging groove 4 due to the urging force of the spring 15.

As the configuration of the paper cutter in the first embodiment, except for the configuration in which the opening portion 16 is formed at the slot 11, and the stopper 30 opening and blocking the opening portion 16 is formed at the flange portion 5, the conventional generally-known configuration, including a configuration of a regulating member 3 regulating a position of unillustrated paper placed on the base 2, a height and a shape of the slider 20, and a method for fixing the cutter 26, and the like, can be used as the configuration of the paper cutter.

Therefore, because the respective component members of the paper cutter 1 can use various modes conventionally used, detailed description of the respective component members will be omitted. Further, the respective component members of the paper cuter 1 in the invention are not limited to the configurations of the respective component members described above, and various modes can be used.

Further, the opening portion 16 of the slot 11 is not limited to being formed at one end of the plate 10, and the opening portions 16 can be formed at the both ends of the plate 10. At that time, the stoppers 30 are preferably formed at the left and right flange portions 5, 5. However, the stopper 30 can be formed at only one of the flange portions 5.

A mode in which the stopper 30 is installed at the flange portion 5 will be described by using FIGS. 2 to 5. However, the mode for installing the stopper 30 at the flange portion 5 is not limited to the modes shown in FIGS. 2 to 5, various modifications are possible. Further, in the configurations shown in FIGS. 2 to 5, vicinity of the opening portion 16 of the slot 11 is enlarged, and descriptions of the respective component members are omitted by using member reference numerals which are the same as that in FIG. 1.

As shown in FIG. 2, the stopper 30 is formed in a shape in which the center of the side surface thereof is formed so as to be a thickness which is substantially the same as the outer circumferential surface of the flange portion 5, and stage-shaped locking pieces 31 are provided at the both end surfaces thereof, and the stopper 30 engages with engaging grooves 4 which have stage portions and formed at the corresponding flange portions 5. The stopper 30 is engaged with the engaging grooves 4 in the direction of the surface of the base 2, whereby appropriate engaging portions 31a formed at the locking pieces 31 of the stopper 30 and unillustrated engaging portions formed at the flange portion 5 engage with one another, and the stopper 3 can be attached to the flange portion 5. At that time, the engaging portions 31a or the unillustrated engaging portions formed at the flange portion 5 can be configured so as to be displaced from the engaging positions to the non-engaging positions by being elastically deformed.

Further, guide grooves into which the engaging convex portions 13 formed at the end portions of the plate 10 are loosely fitted are formed at the back surface side of the thickness portion of the above-described stopper 30. The engaging convex portions 13 formed at the other side of the plate 10 are loosely fitted into the guide grooves which are the same as the guide grooves 8 of the flange portion 5, as shown in FIG. 1, which are disposed at the side opposite to the stopper 30. A pair of unillustrated springs urging the plate 10 in the direction away from the base 2 are disposed at the both end sides of the plate 10, and urges the plate 10 in the direction away from the base 2.

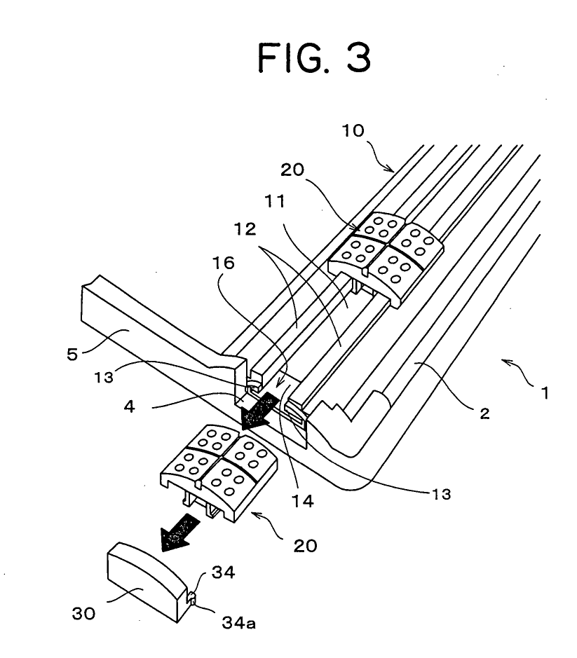

In accordance therewith, when predetermined thrust is applied to the plate 10, paper to be cut can be held between the base 2 and the bottom surface of the plate 10, and a gap into which the paper for being cut is inserted can be formed between the top surface of the base 2 and the bottom surface of the plate 10 by releasing the thrust. Note that, at the stopper 30 shown in FIGS. 3 to 5 as well, guide grooves into which the engaging convex portions 13 formed at the plate 10 are loosely fitted are formed. However, description of the guide grooves will be omitted in the following descriptions.

If the stopper 30 is pulled out of the engaging groove 4 in the direction away from the surface of the base 2, the opening portion 16 of the slot 11 can be opened. If the stopper 30 is engaged with the engaging groove 4, the slider 20 sliding in the slot 11 can be prevented from being taken out of the opening portion 16. Further, if the stopper 30 is pulled out of the engaging groove 4, insertion and taking-out of the slider 20, with respect to the slot 11, can be carried out.

FIG. 3 shows an embodiment in which the stopper 30 is engaged from a side surface side of the flange portion 5. Locking pieces 34 engaging with the flange portion 5 are formed at the stopper 30. The engaging portion 34a is formed at the locking piece 34, and engaging and releasing can be carried out with an unillustrated engaging portion formed at the flange portion 5. At that time, the engaging portion 34a or the unillustrated engaging portion formed at the flange portion 5 can be configured so as to be displaced from the engaging positions to the non-engaging positions by being elastically deformed. In the same way as in the embodiment shown in FIG. 2, the opening portion 16 of the slot 11 can be opened and closed due to engaging and releasing of the stopper 30.

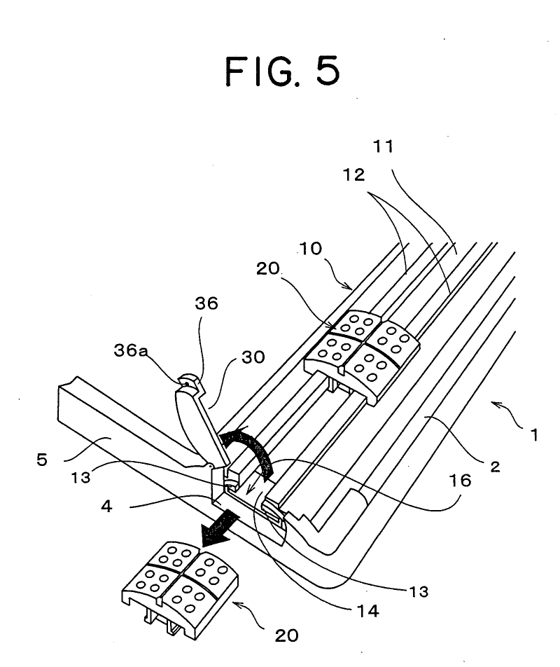

FIGS. 4 and 5 show an example in which the stopper 30 is rotatably supported by the flange portion 5. In FIG. 4, both sides of one end portion of the stopper 30 are rotatably supported by the flange portion 5 such that the stopper 30 rotationally moves in the direction perpendicular to the side surface of the flange portion 5. The opening portion 16 can be opened when the stopper 30 is rotationally moved toward the near side in FIG. 4, and when the stopper 30 is rotationally moved in the opposite direction, projecting portions 35a formed at the stopper 30 and concave portions 35b which are formed at the flange portion 5 and into which the aforementioned projecting portions 35a are contained engage with one another, and the opening portion 16 can be closed. At that time, the projecting portions 35a can be configured so as to be displaced from the engaging positions to the non-engaging positions with the concave portions 35b.

In FIG. 4, a locking mechanism is configured from the projecting portions 35a and the concave portions 35b. The projecting portion in the locking mechanism may be formed at the flange portion 5 side, and the concave portion may be formed at the stopper 30.

In FIG. 5, an example is shown in which one end portion side of the stopper 30 is rotatably supported, and the other end portion serves as a stage-shaped thin locking piece 36, in order for the stopper 30 to be able to rotationally move in the direction parallel to the side surface of the flange portion 5. The stopper 30 can open the opening portion 16 when the stopper 30 is rotationally moved in the counterclockwise direction, by using the rotationally-moving side of the stopper 30 shown in FIG. 5 as the rotationally-moving fulcrum, and can close the opening portion 16 when the stopper 30 is rotationally moved in the clockwise direction.

Shapes of rotationally-moving end surface of the stopper 30 and the side surface portion of the flange portion 5 accepting the rotational end surface are preferably formed in concentric circular arc shapes centering on the center of rotational-movement of the stopper 30. Further, if an engaging portion 36a of the locking piece 36 formed at the other end of the stopper 30 engages with an engaging portion (not shown) formed at the flange portion 5, the stopper 30 can be engaged with the flange portion 5. At that time, the engaging portion 36a or the unillustrated engaging portion formed at the flange portion 5 can be configured so as to be displace from the engaging position to the non-engaging position by being elastically deformed.

(Second Embodiment)

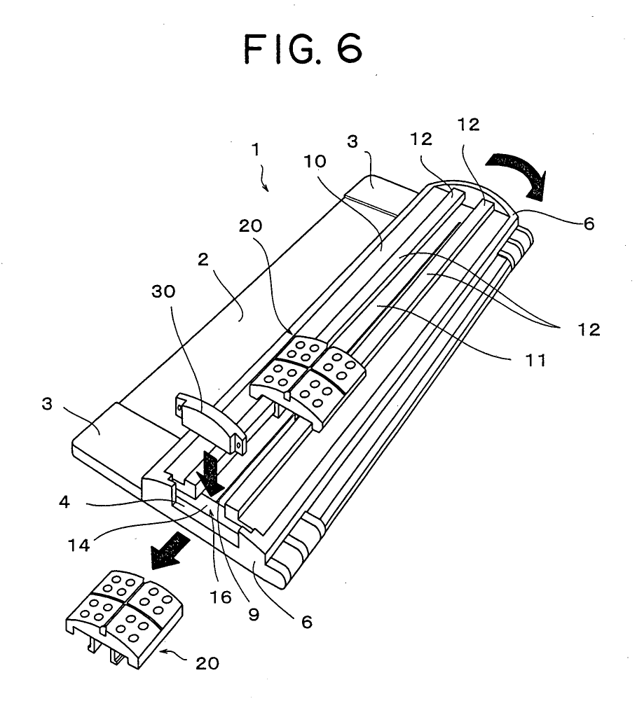

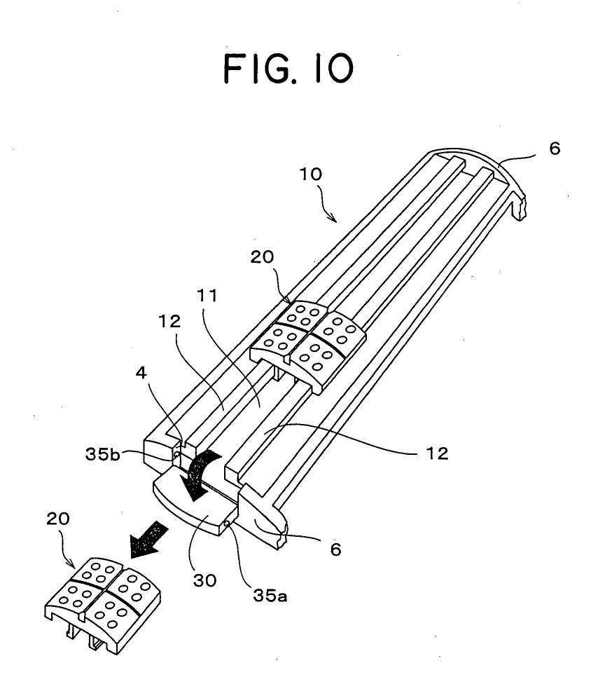

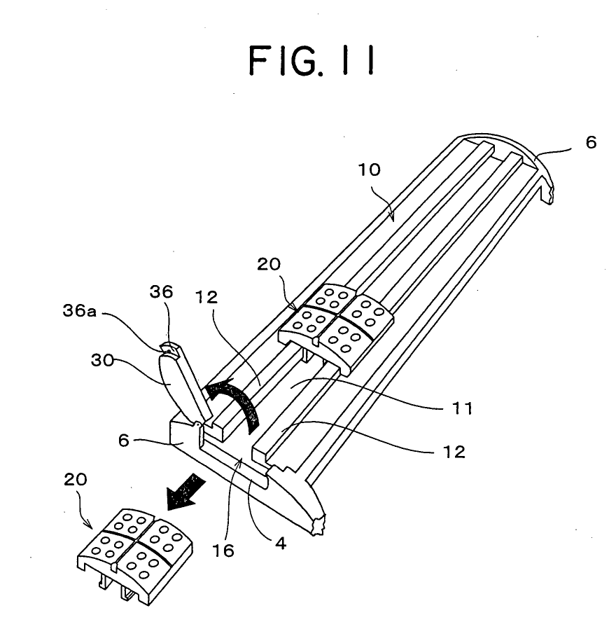

FIGS. 6 to 11 show a second embodiment in which the plate 10 is made to be rotatable with respect to the base 2, and the other configurations except for the configuration in which the plate 10 is rotationally moved have the configurations which are the same as in the first embodiment. Therefore, description of the members will be omitted by using the member reference numerals which are the same as the member reference numerals used in the first embodiment.

Note that, in the first embodiment, an example is shown in which the bridge 14 is formed at least at the end portion, at which the opening portion 16 is provided, of the plate 10. However, because both end portions of the plate 10 in the second embodiment are supported by a pair of arms 6, 6, it is not necessarily needed to form the bridge 14 at the end portion, at which the opening portion 16 is provided, of the plate 10, and in the second embodiment, a case in which the bridge 14 is not formed will be described. In that of the second embodiment, the bridge 14 can be formed.

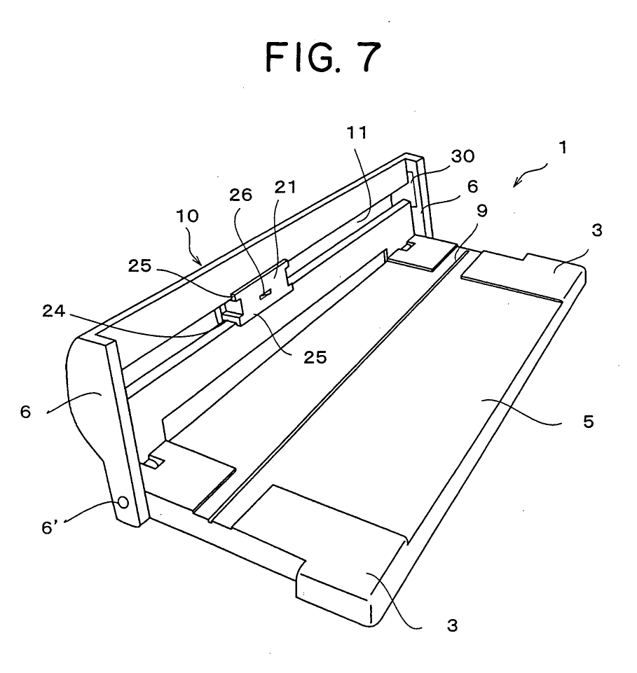

As shown in FIG. 7, the pair of arms 6 is attached to the both ends of the plate 10. The other end portion of the pair of arms 6 is rotatably supported centering on a spindle 6′ by the base 2, and unillustrated paper placed on the base 2 can be pressed by the plate 10 if the pair of arms 6 is rotatably moved in the clockwise direction in FIG. 7, and is folded over in the state shown in FIG. 6.

In the paper cutter 1 shown in FIG. 6, the configuration in which the engaging groove 4 with which the stopper 30 engages is formed at the pair of arms 6, 6 is merely different from the configuration of the paper cuter 1 shown in FIG. 2, and the other configurations are the same as the configurations shown in FIG. 2.

In FIG. 6, an example in which the pair of arms 6 forms a hinge connection by unillustrated hook portions formed at the base 2 and a shaft of rotation which is formed at the pair of arms 6 and engages with the hook portion, and the pair of arms 6 is rotatably supported with respect to the base 2. As the configuration in which the pair of arms 6 is rotatably supported with respect to the base 2, appropriate rotation supporting means, such as a hinge connection, a connection by a spindle, or the like, can be used.

In the state in which paper is pressed by the plate 10, the slider 20 is made to slide along the guide rail 12, whereby the paper (not shown) placed on the base 2 can be cut by the cutter 26 provided at the slider 20. At that time, the front end portion of the cutter 26 can be sunk into a guiding groove 9 formed on the base 2. In place of forming the guiding groove 9 on the base 2, an unillustrated mat or the like may be disposed.

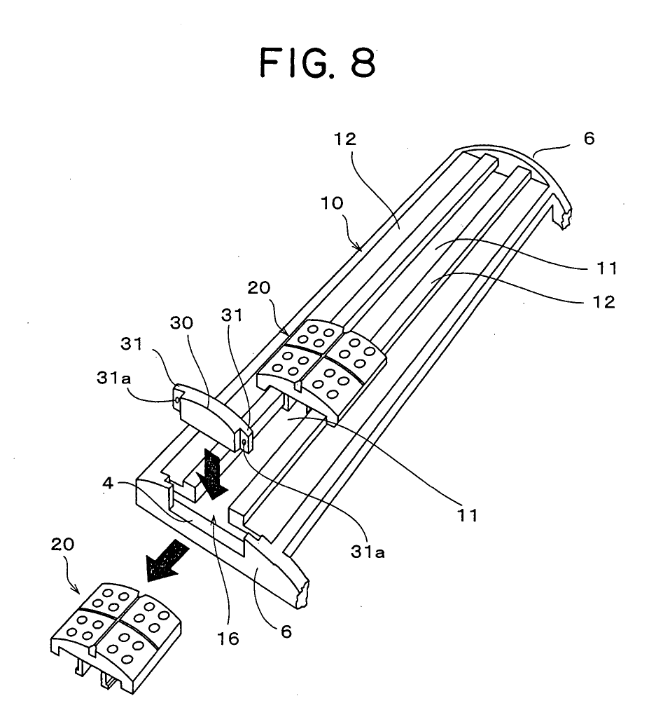

FIGS. 8 to 11 illustrate one part of the arm 6 and the plate 10 being pulled out. In a configuration of attaching the arm 6 and the stopper 30 in FIG. 8, in place of the fact that the configuration of attaching the stopper 30 in FIG. 2 is the flange portion 5, the flange portion 5 is made to be the arm 6. Therefore, the attaching configuration of the stopper 30 and the arm 6 can use an attaching configuration which is the same as the attaching configuration of the stopper 30 and the flange portion 5 in FIG. 2. Description of the attaching configuration of the arm 6 and the stopper 30 in FIG. 8 will be omitted due to the description of the attaching configuration of the stopper 30 and the flange portion 5 in FIG. 2.

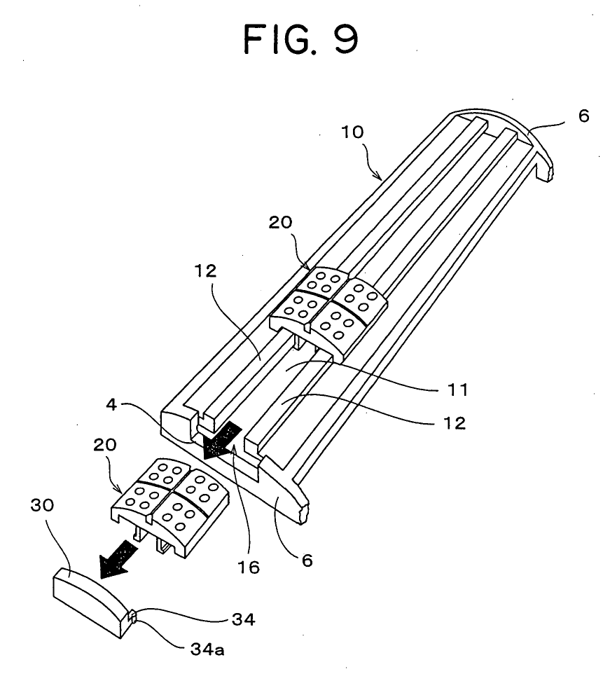

In the same way, as the attaching configurations of the stopper 30 and the arm 6 in FIGS. 9 to 11, attaching configurations which are the same as the attaching configurations of the stopper 30 and the flange portion 5 in FIGS. 3 to 5 can be respectively used. Therefore, description of the attaching configurations of the arm 6 and the stopper 30 in FIGS. 9 to 11 will be omitted due to the descriptions of the configurations of attaching of the stopper 30 and the flange portion 5 in FIGS. 3 to 5.

Further, the configuration in which the slider body 21 and the cover 22 are made to be thick, and thrust by the fingers is easily applied thereto, may be the same configuration as that described in the first embodiment.

(Third Embodiment)

In the first and second embodiments, the examples in which the stoppers 30 are respectively attached to the flange portion 5 and the arm 6 are shown. However, in a third embodiment, an example in which the stopper 30 is detachably attached to the plate 10, or is rotatably attached to the plate 10, is shown.

As the plate 10 in the third embodiment, any of a configuration in which the plate 10 is made to contact and be separated from the base 2 in the direction of the surface by being guided by the flange portion 5 as in the first embodiment, and a configuration in which the plate 10 is made to be rotationally moved with respect to the base 2 by being attached to the arm 6 as in the second embodiment, can be used. Therefore, an attaching configuration in the vicinity of the attaching portion of the stopper 30 and the plate 10 will be described, and the whole body configuration of the paper cutter and the configurations relating to the plate 10 and the flange portion 5 or the arm 6 will be omitted.

However, even when the plate 10 in the third embodiment is made to contact and be separated from in the direction of the surface of the base 2 as in the first embodiment, or even when the plate 10 in the third embodiment is rotationally moved with respect to the base 2 as in the second embodiment it is necessary to form a notched portion at the part facing the stopper 30 in the third embodiment of the flange portion 5 or the arm 6, and to configurate so as not to inhibit the slider 20 from being inserted into the slot 11 or from being taken out of the slot 11.

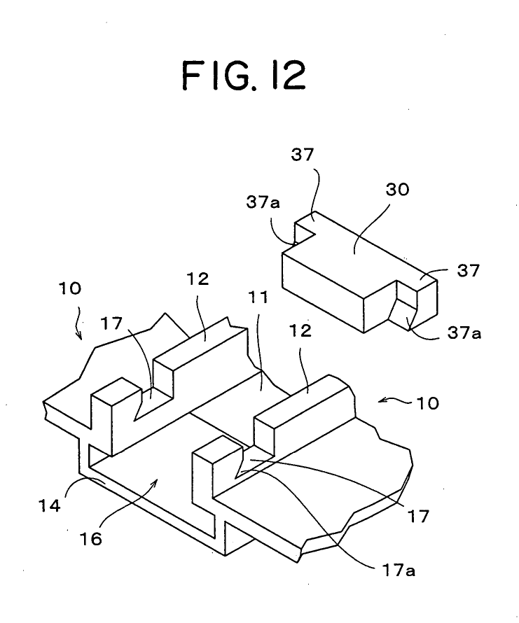

In FIG. 12, an example in which the stopper 30 is detachably attached to the plate 10 is shown. Concave-notch shaped notched portions 17 are formed at the guide rails 12 of the plate 10, and engaging portions 17a are formed at the bottom portions of the notched portions 17, whereby the engaging pieces 37 of the stopper 30 can be detachably fitted into. When the projections 37a are formed at the engaging pieces 37, and are engaged with the engaging portions 17a formed at the notched portions 17, a fitting state between the stopper 30 and the plate 10 can be maintained.

When the stopper 30 is detached from the notched portions 17, the engaging portions 17a or the projections 37a are elastically deformed, and detachment of the stopper 30 from the notched portions 17 can be carried out. Instead of forming the engaging portions 17a at the bottom portions of the notched portions 17, it may be configured such that the stopper 30 and the notched portions 17 is detachably attached by providing a Hook-and-Loop fastener or a removable adhesive at the bottom portions of the notched portions 17.

(Fourth Embodiment)

In FIG. 13, a fourth embodiment in which the stopper 30 is rotatably attached to the plate 10 is shown. One end portion of the stopper 30 is rotatably supported at the plate 10 by a spindle 12′, and an engaging piece 38 formed at the other end portion is fitted into an engaging hole 18 formed at the end portion of the plate 10, whereby the relationship of fixing of the stopper 30 and the plate 10 is maintained, and the opening portion 16 can be closed. Further, if the stopper 30 is rotationally moved in the counterclockwise direction of FIG. 13, the state of engaging of the engaging piece 38 and the engaging hole 18 is released, and the opening portion 16 can be opened.

In the first to fourth embodiments, the examples are described in which the stopper 30 is mechanically attached to the flange portion 5, the arm 6, or the plate 10, so as to be detachably attachable. However, the invention can use, in addition to the above-described attaching configuration, an attaching configuration in which the stopper 30 is detachably attached to the flange portion 5, the arm 6, or the plate 10 by using bonding means which is able to be bonded and removed or engaging-and-releasing means such as a Hook-and-Loop fastener. Further, the mechanical attaching configuration is not limited to the configurations shown in the first to fourth embodiments, and various attaching configurations can be used.

(Fifth Embodiment)

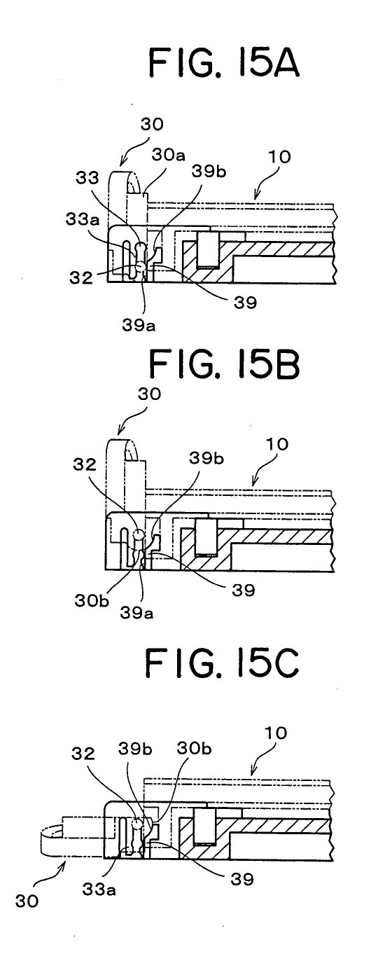

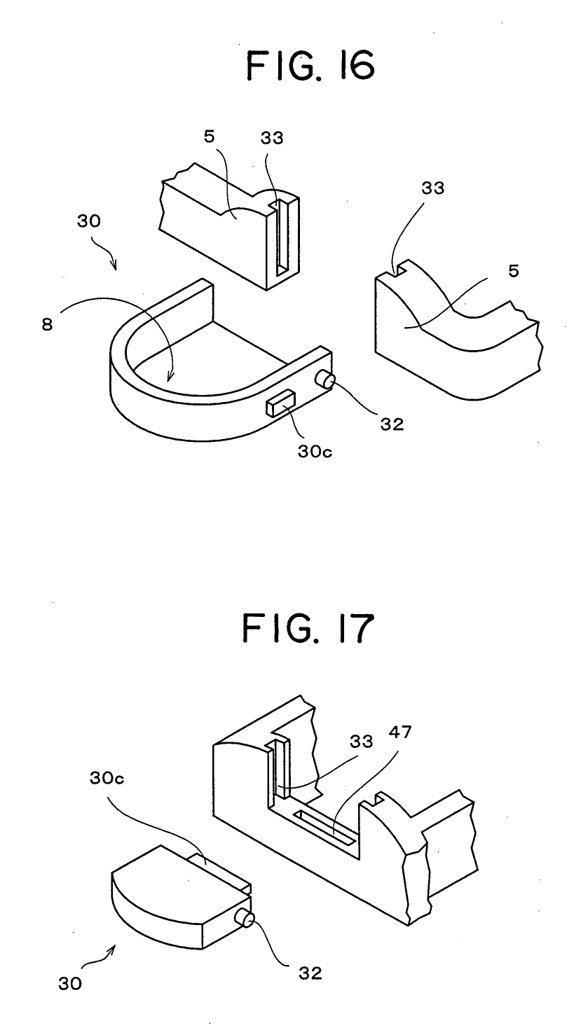

FIGS. 14 to 17 show a fifth embodiment according to the invention. The configuration of the fifth embodiment is configured such that the stopper 30 can be vertically slid in the engaging groove 4 formed at holding member in a standing state, and the stopper 30 can be rotationally moved in the direction of opening or closing the opening portion 16 of the plate 10 at the upper position of the engaging groove 4, and rotational-movement of the stopper 30 is regulated at the lower position of the engaging groove 4. FIGS. 15A to 15C are diagrams for explanation of operating situations of FIG. 14, and FIGS. 16 and 17 respectively show modified examples of the fifth embodiment.

In the configuration in the fifth embodiment, a configuration in which the stopper 30 is vertically slide and a configuration of the rotational-movement of the stopper and the regulation of the rotational-movement of the stopper are different from the configurations of the stopper 30 in the above-described first to fourth embodiments. The other configurations are the same as the configurations in the first to fourth embodiments, and by using the same member reference numerals with respect to the same configuration, descriptions of the members will be omitted.

As shown in FIG. 14, a flange portion 30a is formed at the stopper 30, a guide groove 8 into which the end portion of the plate 10 is loosely fitted is provided at the flange portion 30a. Further, the engaging groove 4 is formed at the flange portion 5 of the base 2, and long grooves 33 into which spindles 32 of the stopper 30 are contained are formed at the both side surfaces of the engaging groove 4. Each one of the long groove 33 opens the bottom tip portion, and has a projecting portion projected to the inside in the vicinity of the bottom tip portion, and a side arm portion at the other side forming the long groove is formed by an elastic piece 33a.

The spindle 32 fitted into the long groove 33 is prevented from falling off by the aforementioned projecting portion. Further, a pair of upper-and-lower projecting portions may formed at the bottom tip portions of the long grooves 33, whereby the spindle 32 of the stopper 30 may be held in the pair of projecting portions. If the spindle 32 is held in the pair of projecting portions, the stopper 30 can be prevented from moving upward.

The elastic piece 33a is deformed into a cantilevered state, whereby the spindle 32 of the stopper 30 can be contained in the long groove 33 from the bottom surface side of the flange portion 5. A rotational-movement regulating member 39 is provided at the plate 10 side of the long groove 33. An arc plane 39b in which an arc-shaped end portion 30b of the stopper 30 can rotationally move without interfering with the rotational-movement regulating member 39, and a vertical plane 39a regulating the rotational-movement of the stopper 30, at the time of rotational-moving of the stopper 30, are provided at the rotational-movement regulating member 39. Guiding means disposed in the engaging groove 4 is configured by the long grooves 33 and the spindles 32.

As shown in FIG. 15A, when the stopper 30 is made to slide to the lower side in the long groove 33 by being made to stand vertically, the outer circumferential surface of the flange portion 30a is regulated by a vertical plane 39a of the rotational-movement regulating member 39, and the rotational-movement of the stopper 30 is prevented. The rotational-movement regulating member 39 may be formed at both side surfaces of the inside of the engaging groove 4, or may be formed at one of the side surfaces.

As in FIG. 15B, when the stopper 30 is straightly lifted up in the long grooves 33, a engagement of the vertical plane 39a and the outer circumferential surface of the flange portion 30a is released, and the stopper 30 can rotationally move in the direction in which the opening portion 16 of the plate 10 is opened with the spindle 32 as the center of rotational-movement. At this time, due to the shape of the arc plane 39b of the rotational-movement regulating member 39, the stopper 30 can be rotationally moved without the arc-shaped end portion 30b of the stopper 30 and the arc plane 39b being interfered with one another.

As shown in FIG. 15C, when the stopper 30 is rotationally moved in the direction in which the opening portion 16 of the plate 10 is opened, the end surface of the stopper 30 can be put on the arc plane 39. The thickness of the stopper 30 is preferably formed such that the top surface of the platform on which the paper cutter 1 is mounted and the stopper 30 contact flatly one another. In accordance therewith, even if an unexpected pressure or the like is applied from the upper side to the stopper 30 in a state in which the stopper 30 is rotationally moved in the opening direction, the spindle 32 of the stopper 30, or the like is prevented from being damaged.

It may be configured such that, instead of making the stopper 30 to be thick, the attaching position of the spindle 32 of the stopper 30 or the like is changed in order for the stopper 30 to flatly contact the surface of the platform on which the paper cutter 1 is mounted.

Although not illustrated in FIGS. 14 and 15A to 15C, the springs 15, as shown in FIG. 1, which urge the plate 10 upward are provided between the plate 10 and the base 2. The springs can be locked with the base 2 when the engaging holes formed at the springs and the projections 15a engage with one another. The upper position of the plate 10 urged upward by the springs is regulated by an engagement between a locking stage portion 39c formed at the rotational-movement regulating member 39 and the engaging piece 10a formed at the plate 10.

In FIG. 16, a configuration in which the long groove 33 formed in the engaging groove 4 is formed in a shape in which the upper side is opened, and a locking piece 30c engaging with the long groove 33 is projected at the upper portion of the stopper 30 in a standing state, is a feature, and this featured configuration is different from the configuration shown in FIG. 14. The locking piece 30c is configured as rotational-movement regulating means. The other configurations are the same as the configurations shown in FIG. 14.

The configuration shown in FIG. 16, if the state of engaging between the engaging piece 30c and the long groove 33 is released because the stopper 30 is once slid upward, the stopper 30 can be freely moved rotationally. Moreover, because the stopper 30 can be slid downward along the long groove while being in a rotationally moved state, the opening portion 16 of the plate 10 can be broadly opened. At this time, it is preferably configured such that the stopper 30 and the platform on which the paper cutter 1 is mounted are in a state of a flat contact one another.

FIG. 17 has a feature of a configuration in which the locking piece 30c is formed at the bottom tip portion of the stopper 30 in a standing state, and a locking groove 47 with which the locking piece 30c engages is formed at the flange portion 5 of the base 2 or the arm member 6, and the featured configuration is different from the configuration shown in FIG. 16. The locking piece 30c is configured as rotational-movement regulating means.

Further, the point that the engaging groove 4 with which the stopper 30 engages is formed on the arm 6 is different from the configuration shown in FIG. 16. The other configurations are the same as the configurations in FIG. 16. The spindle 32 formed at the stopper 30 is loosely fitted so as to be slidable and rotatable in the long groove 33.

The stopper 30 can be inserted along the long groove 33. It may be configured such that a projecting portion projecting to the inside or the like is formed at the top end portion of the long groove 33, and because the spindle 32 of the stopper 30 is fitted into the long groove 33 from the projecting portion, the stopper 30 is prevented from being pulled out of the long groove 33 by the projecting portion.

In the fifth embodiment, the examples of the configuration in which the stopper 30 is held at the flange portion 5 on the base 2, and the configuration in which the stopper 30 is held at the arm member 6 are described. However, as in the illustrated examples, the stopper 30 is not limited to being held at the flange portion 5 or at the arm member 6, and may be configured so as to be held at both of the flange portion 5 and the arm member 6.

The spindle 32 of the stopper 30 may be formed in a shape in which the longitudinal sectional shape is an oblong, and a groove width at the top end portion of the long groove 33 may be configured in a shape in which the oblong spindle 32 rotationally moves. At this time, when the spindle 32 is positioned in the vicinity of the bottom end portion of the long groove 33, the rotational-movement of the stopper 30 can be regulated between the outer circumferential surface in the direction of the major axis at the oblong of the spindle 32 and the long groove 33, and the rotational-movement of the stopper 30 can be regulated in association with regulation on the rotational-movement by the rotational-movement regulating member 39, regulation on the rotational-movement by engagement between the locking piece 30c and the long groove 33, or regulation of the rotational-movement by engagement between the locking piece 30c and the locking groove 47.

(Sixth Embodiment)

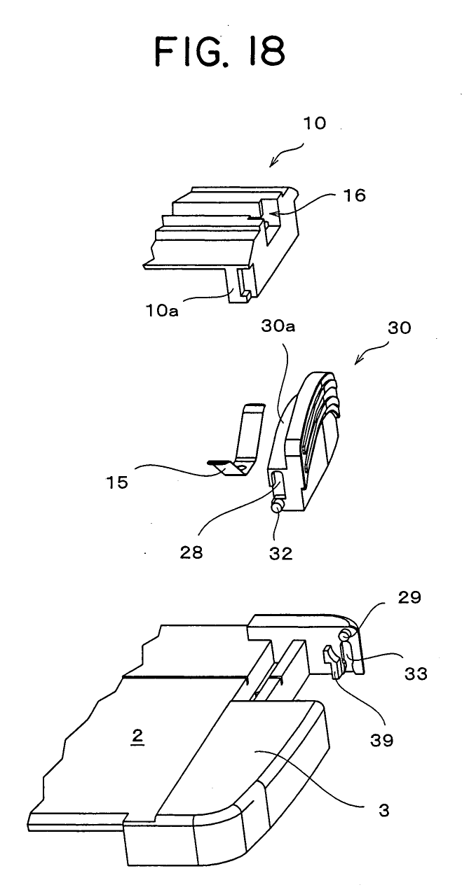

In FIGS. 18 to 20, a sixth embodiment according to the invention is shown. In a configuration in the sixth embodiment, a configuration having maintaining means which can maintains the stopper 30 in a standing state by regulating the rotational-movement of the stopper at a position where the stopper 30 is raised and which can make the stopper 30 descends in the standing state is different from the configuration in the above-described fifth embodiment. Other configurations are the same as the configurations in the fifth embodiment, and with respect to the same configurations, descriptions of the members will be omitted by using the same member reference numerals.

Further, in the fifth embodiment, the rotational-movement regulating means regulating the rotational-movement of the stopper 30 can be configured so as to have the rotational-movement regulating member 39. However, in the sixth embodiment, because the rotational-movement of the stopper 30 can be regulated by guiding means and maintaining means, in the sixth embodiment, it is not necessarily needed to provide the rotational-movement regulating member 39 described in the fifth embodiment.

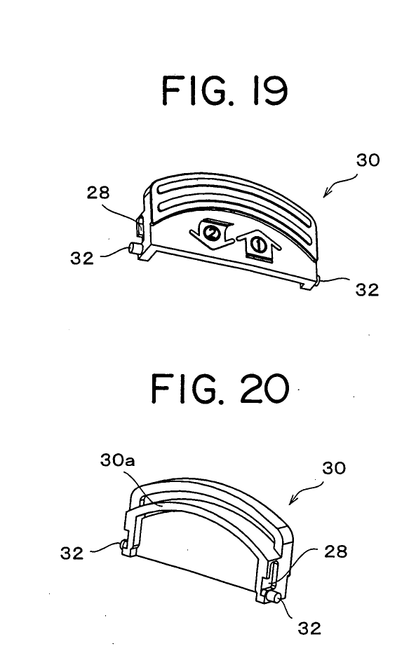

In FIGS. 19 and 20, a view in which the stopper 30 is looked from the surface side thereof, and a view in which the stopper 30 is looked from the back surface side thereof are respectively shown. Guiding grooves 28 in addition to the spindles 32 are formed at the side end surfaces of the stopper 30. As shown in FIG. 18, the guiding groove 28 is formed in a shape in which one end portion is opened to the plate 10 side.

The guiding means disposed in the engaging groove 4 is configured by the spindle 32 of the stopper 30 and the long groove 33 formed at the inside surface of the engaging groove 4. As the long groove 33, as described in the description of FIG. 14 according to the fifth embodiment, the projecting portions for preventing falling off which are formed at the elastic piece 33a and the bottom end portion of the long groove 33 can be formed. Further, a pair of upper-and-lower projecting portions may be formed at the bottom end portion of the long groove 33, and the spindle 32 of the stopper 30 can be held in the pair of projecting portions. The spindle 32 is held in the pair of projecting portions, whereby the stopper 30 is prevented from being moved upward.

The guiding grooves 28 are formed at the surfaces on which the spindles 32 of the stopper 30 are formed so as to be in a state in which the bottom end portions thereof are opened. Further, at an ascended position of the stopper 30, pins 29 which are in an engaging state or a non-engaging state with the above-described guiding grooves 28 when the stopper 30 is rotationally moved around the spindle 32 are provided at the engaging groove 4. The pins 29 and the guiding grooves 28 may be formed at the left and right of the stopper 30 as pairs, or may be formed at one side of the stopper 30.

When the stopper 30 is raised, and moreover, the stopper 30 is rotationally moved in the direction in which the opening portion 16 of the plate 10 is blocked, the pins 29 can be inserted from the opening of the guiding grooves 28. If the stopper 30 is made to descend along the long groove 33 and the guiding groove 28 from this state, the stopper 30 can be set on the paper cutter.

Further, if the spindle 32 of the stopper 30 is held by the pair of upper and lower projecting portions at the bottom end portion of the long groove 33 described above, the stopper 30 can be prevented from being raised by the plate 10 inserted in the flange portion 30a of the stopper 30 due to urged force of the springs. The plate 10 urged upward due to the urging force of the springs 15 can be prevented by an engagement between the locking piece 10a formed at the end portion of the plate 10 and the locking stage portion 39c of the rotational-movement regulating member 39.

(Seventh Embodiment)

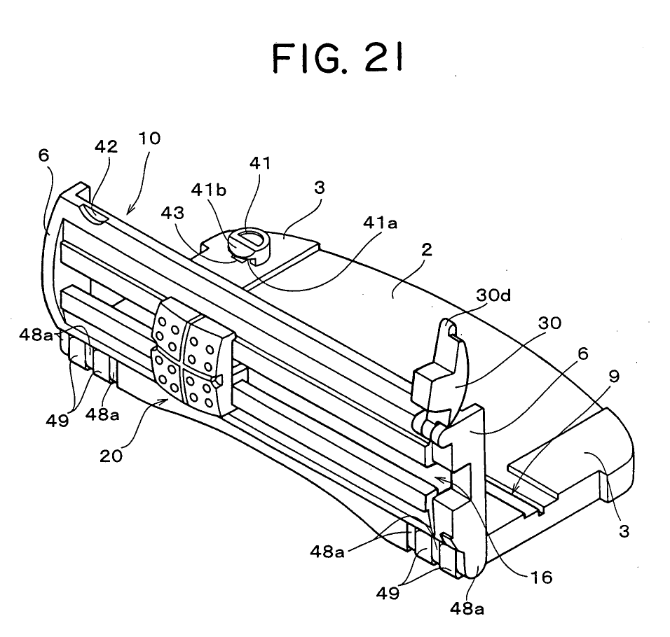

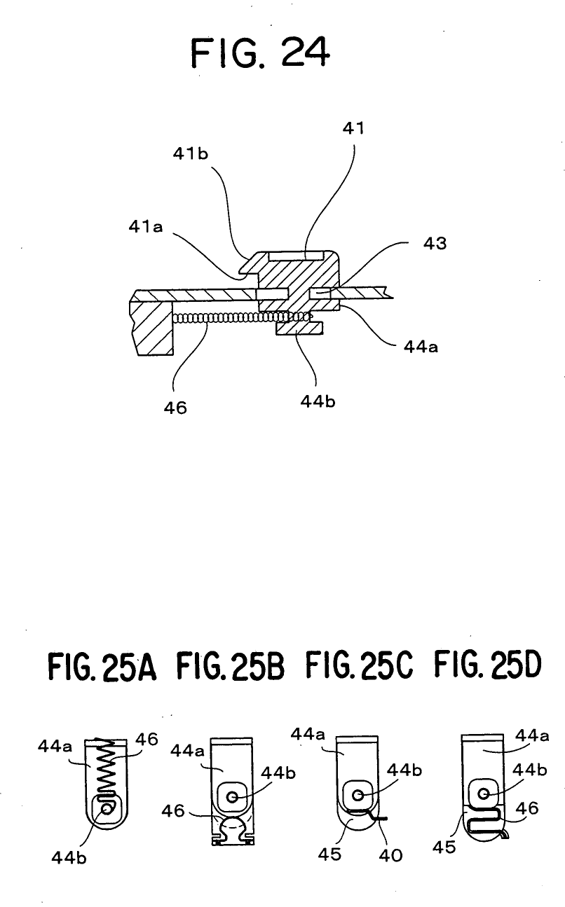

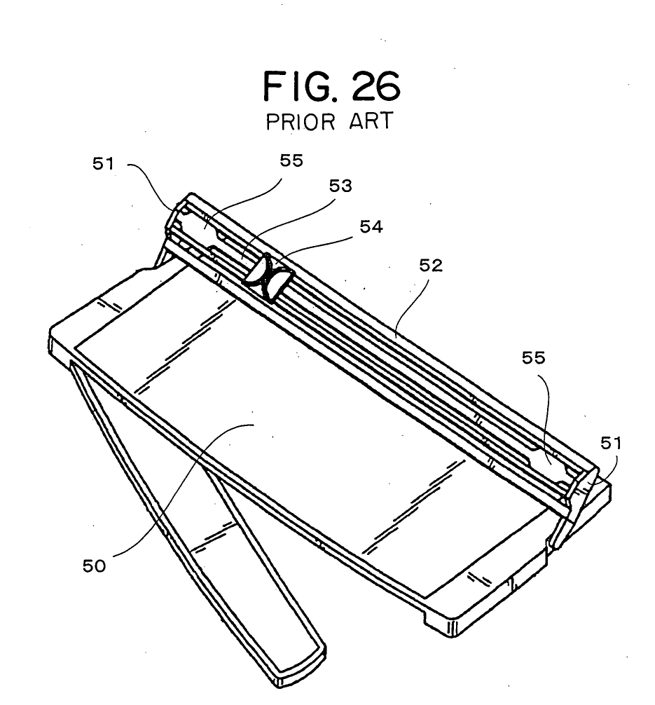

FIGS. 21 to 25D show a seventh embodiment according to the invention. In the seventh embodiment, a configuration in which the plate 10 can be locked with the base 2 is a feature. Therefore, the seventh embodiment can be applied to the paper cutters shown in the first to sixth embodiments in addition to the paper cutter shown in the sixth embodiment.

Among members used in the configuration in the seventh embodiment, with respect to the members which are the same as the members used in the above-described first to sixth embodiments, descriptions of the members will be omitted by using member reference numerals which are the same as the member reference numerals used in the first to sixth embodiments. Hereinafter, configurations which are different from those of the above-described first to sixth embodiments will be described. Note that the configuration relating to the paper cutter described in the seventh embodiment is not limited to the seventh embodiment, and can be applied as the configurations in the above-described first to sixth embodiments.

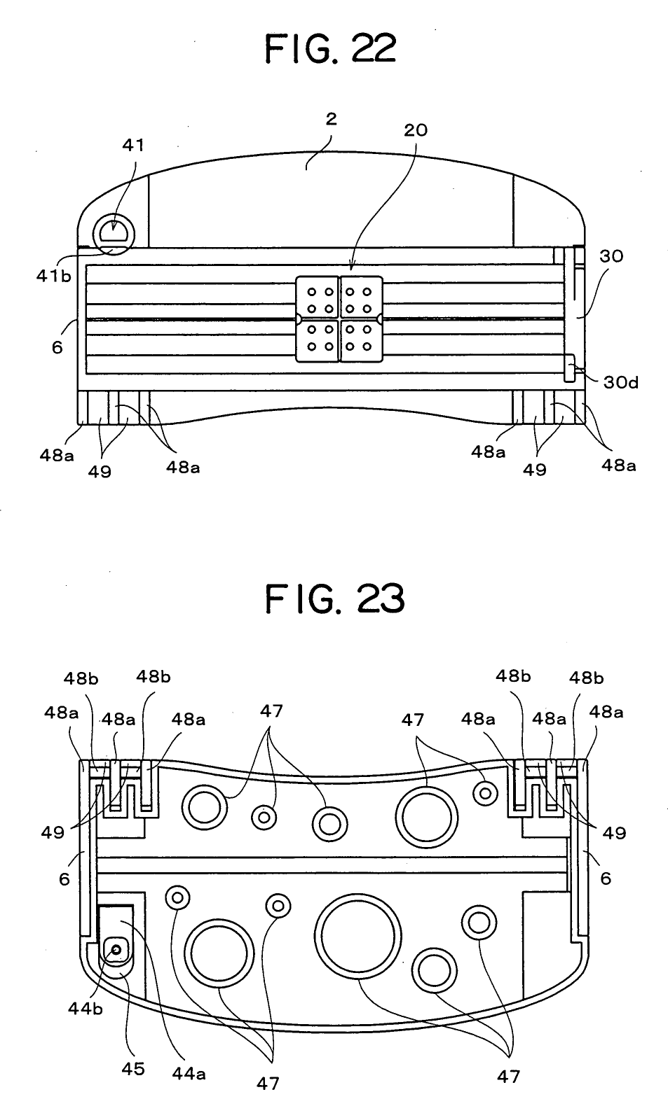

FIG. 21 is a perspective view showing a state in which the pair of arms 6, 6 is rotationally moved in a direction in which the plate 10 is away from the base 2, and the stopper 30 is rotationally moved with respect to the arms 6. FIG. 22 shows a top plan view of the paper cutter 1, and FIG. 23 shows a bottom plan view of the paper cutter 1.

As shown in FIG. 21, a locking groove 42 is formed at a part of a side edge of the plate 10. In a state in which the plate 10 is folded over the base 2, a locking member 41 having a locking piece 41a engaging with the aforementioned locking groove 42 is disposed on a regulating member 3 of the base 2. The locking member 41 is fitted and inserted into a long hole 43 formed at the regulating member 3, and is configured so as to be able to contact and separate from the side edge of the plate 10 along the long hole 43.

The guide groove 45 is formed at the back surface side of the regulating member 3 as shown in FIG. 23, and the aforementioned long hole 43 is formed at the intermediate portion in the cross direction of the guide groove 45. As shown in FIG. 23, a nipping piece 44a contained in the guide groove 45 so as to freely slide and the locking member 41 are linked and fixed via the long hole 43 by a screw 44b. Further, an elastic member 46 is interposed between the nipping piece 44a or the screw 44b, and the front end portion side of the guide groove 45, and urges the locking member 41 toward the side edge side of the plate 10.

An inclined plane 41b is formed at the plate side top surface of the locking member 41, and the back surface side of the side edge at the plate 10 touches an inclined plane 42b of the locking member 41 when the plate 10 is folded over, and the locking member 41 can be withdrawn backward with resisting the urging force of the elastic member 46 by the inclined plane 41b. In accordance therewith, the operation of laying-down of the plate 10 is not prevented by the locking member 41.

Further, when the plate 10 slides down on the inclined plane 41b and approaches the base 2 side, the locking member 41 advances toward the plate 10 side by an urging force of the elastic member 46, and the locking piece 41a of the locking member 41 and the locking groove 42 formed at the plate 10 engage with one another. In accordance therewith, the plate 10 can be held at a position close to the base 2.

When the elastic member 46 applying an urging force to the locking member 41 is not provided, the locking member 41 withdrawn by the operation of laying-down of the plate 10 is manually advanced, whereby the locking groove 42 of the plate 10 and the locking piece 41a of the locking member can be engaged with one another.

In the case that the plate 10 is configured so as to be able to contact and separate from the surface of the base 2 in the substantially upper and lower direction, if the engaging groove 42 engages with the locking piece 41a of the locking member 41 being formed at the plate 10, the locking member 41 can be withdrawn by an action with the inclined plane 41b when the plate 10 is approached toward the base 2 side in the same way in the above-described case. Further, after the plate 10 slides down on the inclined plane 41b, the locking member 41 is advanced by the urging force of the elastic member 46 and the locking piece 41a of the locking member 41 and the locking groove 42 of the plate 10 can be engaged with one another.

The configuration of the elastic member 46 urging the locking member 41 can be a configuration such as shown in FIGS. 25A to 25D. One example in which a coil spring is used is shown in FIG. 25A, and as the coil spring, a compression spring or an extension spring can be used. In FIG. 25A, an example in which the extension spring is used is shown.

As the elastic member 46, a plate spring or the like can be used in addition to a coil spring, and examples in which the plate spring is used are shown in FIGS. 25B to 25D. In FIG. 25B, an example in which the plate spring is formed in an Ω shape is shown, and an example in which the plate spring is used so as to be cantilevered is shown in FIG. 22(c), and an example in which the plate spring is wound in a zig-zag shape is shown in FIG. 25D. The end portion of the plate spring can be held in such a manner that it is fitted into and fixed to a notch, or the like, made for accepting and fixing the plate spring formed at the back surface side of the base 2 or that it is loosely fitted into a groove, or the like, for holding the plate spring.

Note that the configuration of the elastic member 46 urging the locking member 41 and the area of the locking member 41 pressed by the elastic member 46 are not limited to the examples of the configurations shown in FIGS. 25A to 25D, and as long as it is a configuration in which the locking member 41 can be urged toward the side edge side of the plate 10, any configuration can be used. Further, the elastic member 46 is not necessarily a required configuration, and it may be configured without using the elastic member 46.

As shown in FIGS. 21 and 23, flange portions 48a having rotatable supporting shafts 48b are formed at both corner portions of the side edge at one side of the plate 10. The rotatable supporting shafts 48b engage with shaft rotatable supporting portions 49 formed at the base 2, and the arm 6 can be rotationally moved around the shaft rotatable supporting portions 49 serving as the center of rotational-movement. The cross section of the shaft rotatable supporting portion 49 is formed in a substantially C-shape, the rotatable supporting shaft 49a can be fitted thereto from the C-shape opening side engaged therewith.

A mechanism of rotational-movement of the arm 6 is a configuration which is the same as the mechanism of rotational-movement described in FIG. 6 of the second embodiment. The mechanism of rotational-movement of the arm 6 is different from the mechanism of rotational-movement shown in FIG. 7 in the second embodiment. However, the mechanism of rotational-movement shown in FIG. 7 may be applied as the mechanism of rotational-movement in the sixth embodiment.

As shown in FIG. 21, a lever 30d making the stopper 30 rotationally move is formed at the stopper 30. As shown in FIG. 22, the lever 30d is partially spaced from the top surface of the plate, and if the fingers or the like are inserted into the spaced area, the stopper 30 can be easily rotationally moved with respect to the arm 6 as shown in FIG. 21. Note that the configuration of the lever 30d formed at the stopper 30 and the configuration in which the lever is formed at the arm 6, as shown in FIG. 21, which is for mounting thereon, can be applied as the configurations in the above-described first to seventh embodiments in which the stopper 30 is rotationally moved.

As shown in FIG. 23, there are provided ribs 47 formed at the back surface side of the base 2 in order to prevent the surface of the base 2 from being warped. A shape of the ribs 47 is not limited to a circle, and as long as the ribs can prevent the surface of the base 2 from being warped and provide strength to the base 2, the rib can be configured in any shape which is appropriate for the required number and the required areas. Further, ribs or the like which provide strength to the base 2 may be formed at the outer peripheral portion of the base 2 or the like.

In the above-described respective embodiments, when the plate 10 is configured so as to be rotatable by the arm 6, a torsion spring or the like is interposed in the mechanism of rotational-movement of the arm 6, whereby it can be configured such that the plate 10 is always urged in the opening direction.

1. A paper cutter comprising:
a base;
a rectilinear plate which is disposed on the base, and which is able to contact and separate with respect to the base;
holding members which guide the plate so as to make it contact and separate with respect to the base, and which hold the plate;
a slot formed along a direction of a length of the plate; and
a slider which is accepted in the slot so as to be able to slide, and which has a cutter,
being characterized in that the slot has an opening portion opening at least up to one end portion of the plate, and
a stopper which opens and blocks the opening portion is disposed at a portion of the holding members facing the opening portion or disposed in the vicinity of the opening portion of the plate.

2. The paper cutter according to claim 1, wherein one of the holding members is a pair of arm members which is rotatably supported by the base, and which rotatably supports the plate with respect to the base.

3. The paper cutter according to claim 1, wherein one of the holding members is a flange portion which is installed upright at a peripheral portion of the base, and the flange portion has a guide groove into which the plate is loosely fitted and is guided in a direction of a surface of the base.

4. The paper cutter according claim 1, wherein the stopper is disposed so as to be rotatable with respect to the holding members or the plate.

5. The paper cutter according claim 1, wherein the stopper is disposed so as to be detachably attachable with respect to the holding members or the plate.

6. The paper cutter according to claim 1, comprising:
guiding means for vertically sliding and guiding the stopper in an engaging groove formed at the holding members; and
rotational-movement regulating means for locking the stopper so as not to be rotatable with respect to the holding members, at a position where the stopper is made to descend, in a standing state, by being guided by the guiding means,
wherein, at a position where the stopper in a standing state is made to ascend by being guided by the guiding means, regulation on rotational-movement by the rotational-movement regulating means is released, and the stopper is rotatably supported in directions in which the opening portion of the plate is opened and blocked.

7. The paper cutter according to claim 1 comprising:
guiding means for vertically sliding and guiding the stopper in an engaging groove formed at the holding members; and
maintaining means, which is provided at the guiding means, for allowing the stopper to rotationally move in the directions in which the opening portion of the plate is opened and blocked, at an ascended position of the stopper guided by the guiding means, and for maintaining the stopper, which is made to descend by being guided by the guiding means, in a standing state, when the stopper is rotationally moved in the direction in which the opening portion of the plate is blocked.

8. The paper cutter according to, claim 1 further comprising:
a locking member engaging with a part of a side edge of the plate in a state in which the plate is close to the base side,
wherein the locking member is fitted and inserted into the part of the side edge of the plate on the base so as to be able to contact and separate with respect to the part of the side edge.

9. The paper cutter according to claim 8, wherein the locking member is urged toward the part of the side edge of the plate.
